(19) United States
(12) Patent Application Publication
(10) Pub. No.: US 2017/0351733 A1
(43) Pub. Date: Dec. 7, 2017

(54) USER ADDRESS MATCH BASED ON MATCH QUALITY

(71) Applicant: Facebook, Inc., Menlo Park, CA (US)

(72) Inventors: Li Zhou, Campbell, CA (US); Ba Quan Truong, East Palo Alto, CA (US)

(21) Appl. No.: 15/173,582

(22) Filed: Jun. 3, 2016

(51) Int. Cl. G06F 17/30; G06Q 30/02; G06F 21/62; G06Q 50/26

(52) U.S. Cl. CPC G06F 17/30392; G06Q 50/265; G06Q 30/0255; G06F 17/3033; G06F 17/30598; G06F 21/6254

(57) ABSTRACT

An online system generates a custom audience for an advertiser from an advertiser-provided list of customers. In order to generate the custom audience, the online system determines a set of attributes corresponding to a received match priority selection and performs a match of the customers with users of the online system based on the determined set of attributes. The custom audience is supplemented with street addresses associated with the matched users of the online system. Content specific to the determined street addresses may then be provided to the matched users.

### FIELD OF ART

This disclosure generally relates to online systems, and, more specifically, to performing user address matching based on a specified level of match quality.

### BACKGROUND

Organizations may wish to contact their known users, or those like them, in order to send them online content, for example, via an online system. While those organizations may wish to use the online system's services to provide the content to the organizations' users, those organizations may wish to only send certain limited information about their known users to the online system. The organization may wish to keep confidential the actual list of its users and their identities. Thus, for the online system to effectively target content to those users of the organization, the online system must perform a match of those users to the online system's own store of user information about its users. However, some online content may be most appropriate for users in a certain location since the content may relate to a service that is available only in that location. In those situations, it is helpful to know the street address of each user to ensure that the current user is provided with the location-specific content. Currently it is difficult to target such location-specific content to the organizations' users because the online system may not have access to specific street address information for each of the specific users.

### SUMMARY

An online system such as a social networking system allows an organization to target location-specific content to its users and, in some cases, to generate a custom audience of users for content based on known information about users including street addresses of those users. The organization (e.g., a company or business) provides a list of one or more users to the online system with whom the organization would like to communicate or to whom the organization would like to send location-specific content (e.g., an online offer of a karate class on a specific street in Mountain View, Calif. to a user with a nearby street address in Mountain View, Calif.). In various embodiments, the list of current users may be a list or database including one or more hashed personally identifying information (PIT) associated with a customer. PII associated with a user may be at least one of a first name, last name, one or more geographic elements (country, city, or state), date of birth (DOB), or email address. The online system matches the hashed list of users provided by the organization with users of the online system. In one or more embodiments, the PII associated with users of the online system may be prehashed, and the hashed customer PII received from an organization is compared to the hashed user PII.

The organization may select a match priority indicating a minimum level of match quality and a set of PII attributes corresponding to a particular level of match quality. A selected match priority indicates a preference, by the organization, to prioritize a match for either match coverage versus match accuracy. That is, if the organization selects to prioritize the match for coverage over quality, the online system performs a match based on a set of PII attributes comprising, for example, zip code, first name, city, etc. Alternatively, if the advertiser selects to prioritize match accuracy over match coverage, the online system matches the customers identified by the advertiser to users of the online system based on a set of PII attributes comprising, for example, s an email address. In still other embodiments, the online system may enlarge a generated custom audience for the content with additional users who are connected, in some way, to one or more users of the online system matching customers of the organization.

In order to generate a custom audience for receiving the content (e.g., a custom audience for location-specific content might be all males between 18-25 who have a street address in Mountain View, Calif.), the online system is configured to determine a physical address (such as a street address) associated with the matched users. In some embodiments, the physical street address may be inferred from location information received from a user device or a social networking object associated with the user. In other embodiments, the online system communicates with a third party database to receive a street address associated with a matched user.

### BRIEF DESCRIPTION OF THE DRAWINGS

FIG. 1 is a block diagram of a system environment in which an online system operates, in accordance with one embodiment.

FIG. 2 is a system diagram of the online system, in accordance with one embodiment.

FIG. 3 illustrates a graphical user interface generated by the online system to an advertiser, using which the advertiser can create a custom audience in accordance with one embodiment.

FIG. 4 is a flow chart of a method for generating custom audiences, in accordance with one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

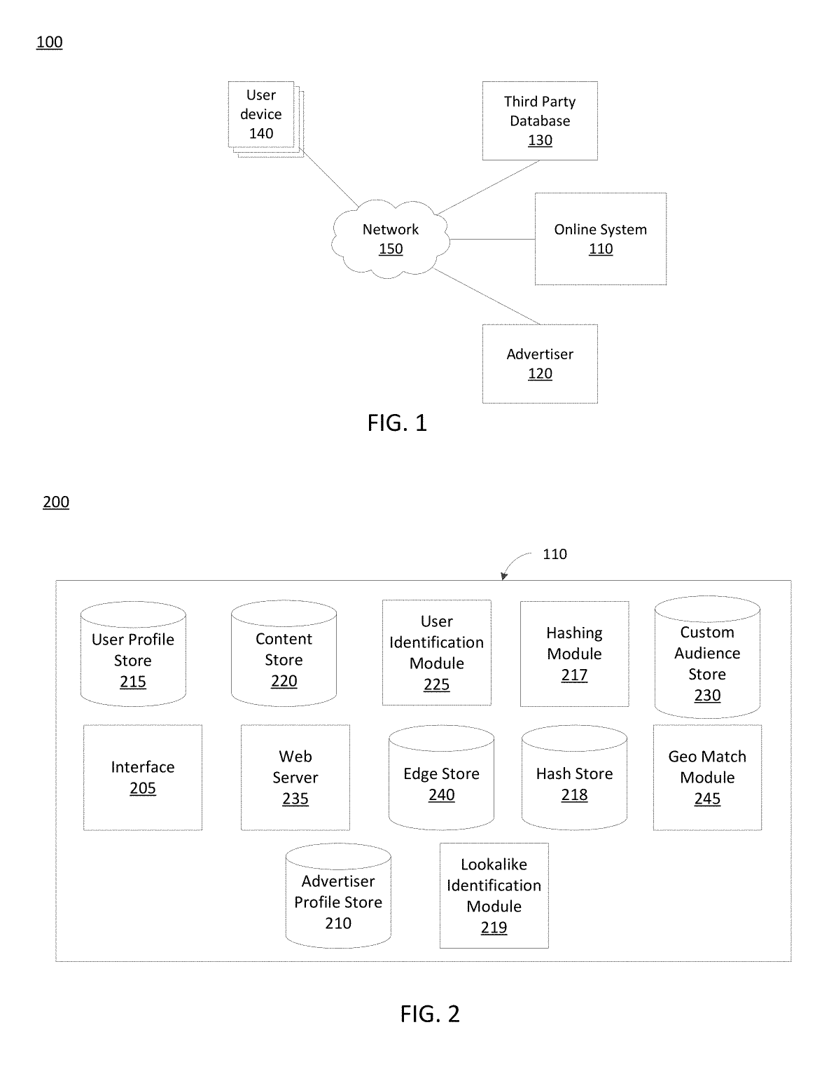

FIG. 1 is a block diagram of a system environment 100 for an online system, such as a social networking system in accordance with an embodiment. The system environment 100 shown by FIG. 1 comprises an online system 110, an advertiser 120, a third-party database 130, and one or more user devices 140. In one embodiment, the online system 110 communicates with a user device 140, an advertiser 120, and a third-party database 130 via network 150. For example, the advertiser 120 provides one or more (e.g., hashed) customer lists comprising one or more customers associated with the advertiser 120 to the online system 110. The online system 110 may match one or more users of the online system 110 to customers of the advertiser based on the hashed customer lists received from the advertiser 120. Based on the information stored in the online system 110 associated with the matched users of the online system 110, the online system 110 determines physical addresses (e.g., street addresses) associated with the customers of the advertiser 120, generates a custom audience whose information includes the determined physical addresses, and transmits the generated custom audience to the advertiser 120. In alternative configurations, different and/or additional components may be included in the system environment 100. As used herein, the term customer refers to customers associated with the advertiser 120.

The user devices 140 are one or more computing devices capable of receiving user input as well as transmitting and/or receiving data via the network 150. The user device 140 may be associated with a user of the online system 110. In one embodiment, a user device 140 is a conventional computer system, such as a desktop or a laptop computer. Alternatively, a user device 140 may be a device having computer functionality, such as a personal digital assistant (PDA), a mobile telephone, a smartphone or another suitable device. A user device 140 is configured to communicate via the network 150. In one embodiment, a user device 140 may execute an application allowing a user of the user device 140 to interact with the online system 110. For example, a user device 140 executes a browser application to enable interaction between the user device 140 and the online system 110 via the network 150. In another embodiment, a user device 140 interacts with the online system 110 through an application programming interface (API) or a software development kit (SDK) running on a native operating system of the user device 140, such as IOS® or ANDROID™.

In one or more embodiments, a user of the online system 110 has an associated profile on the online system that maintains demographic information associated with the user. Users may provide the online system 110 either indirectly or directly with a geographic location, such as a geographical coordinate (e.g., a GPS coordinate). In other embodiments, a user may provide the online system 110 with personally identifiable information (PII) about the user, e.g., by directly specifying the PII. In some embodiments, the online system 110 may infer the PII from actions of the user and may provide the user with an option to delete the derived PII. PII may comprise one or more attributes. Examples of possible PII include a first name, a last name, a date of birth, a race, an income bracket, a shopping habit, one or more interests, for example. In still other embodiments, users also provide the online system 110 with additional PII attributes such as a telephone number including an area code associated with a defined geographic location and street address indicating a street address.

The user device 140 is configured to communicate with the online system 110 via the network 150, which may comprise any combination of local area and/or wide area networks, using both wired and/or wireless communication systems. In one embodiment, the network 150 uses standard communications technologies and/or protocols. For example, the network 150 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 150 may be represented using any suitable format, such as hypertext markup language (HTML) or extensible markup language (XML). In some embodiments, all or some of the communication links of the network 150 may be encrypted using any suitable technique or techniques.

One or more third party databases 130 may be coupled to the network 150 and available for communication with the online system 110, which is further described below in conjunction with FIG. 2. The third party databases 130 provide a way for the online system 110 to obtain additional street address information to supplement its own. In one embodiment, a third party database 130 includes street addresses indexed by one or more types of PII. As one example, the third-party database 130 may be a database of street addresses indexed by a first name, a last name, and a phone number. In still other embodiments, the third-party database 130 is a tile service configured to receive a geo-tile from the online system 110 and provide one or more street addresses associated with the received geo-tile. In another embodiment, the third-party database 130 maintains street address information defined by a standard that governs the format of the street number, street name, city, state/province and zip code (e.g., ISO 3166). In additional embodiments, the third-party database 130 maintains street address information in one or more different standards with each standard associated with a different geographic location and the online system 110 is configured to normalize street addresses. The process of determining street address information associated with a user is described below in conjunction with FIG. 2.

As mentioned above, the system environment 100 also includes an online system 110. In one embodiment, the online system 110 is a social networking system that maintains one or more user profiles associated with user devices 140. As used herein, a user of the online system 110 may also be referred to as a “user” and is understood to be associated with a user device 140. The online system 110 maintains connections between one or more users of the online system 110 including one or more social networking objects associated with those users. A social networking object may be a post, a picture, an interest or any combination thereof. In some embodiments, the online system 110 also maintains social context between a user associated with a user device 140 and one or more social networking objects maintained by the online system 110. In other embodiments, the online system 110 provides a graphical user interface (GUI) to advertisers and marketers to define and generate a custom audience to enable a mail marketing campaign. Advertisers 120 may also define and generate a custom audience through an API. Generating and defining a custom audience is further described, in detail, below in conjunction with FIG. 2.

The system environment 100 also contains one or more advertisers 120. The advertiser 120 may provide a list of customers that the advertiser 120 would like to target with a direct mail marketing campaign. The customer list may include one or more customer names and at least one PII associated with each customer. For example, the customer list comprises a list of email addresses, phone numbers, or other identifying information associated with a customer name.

In one embodiment, the customer list does not contain the actual data of the customer records (e.g., customer name), but instead includes only a hash of the data, which serves to protect privacy of the customers by not disclosing details of the customers to the online system 110. In such embodiments, the advertiser 120 accomplishes the hashing either directly (e.g., by using an API of the online system 110), or implicitly (e.g., by JavaScript or other scripting language code in a customer list submission web page of the online system 110 implicitly performing hashing of the provided customer list data).

In one or more embodiments, the data provided by the advertiser 120 may also include one or more targeting criteria. Targeting criteria specify characteristics of online system users to receive a marketing campaign associated with an advertiser 120. For example, the advertiser 120 may use targeting criteria to identify one or more online system users likely to be interested in a product or service associated with the advertiser 120. Conventionally, advertisers 120 identify information associated with online system users (e.g., demographic information in a user's profiles maintained by an online system 110) as targeting criteria to identify users eligible to be presented with a sponsored content item. In various embodiments, the online system 110 generates a custom audience by matching one or more targeting criteria specified by an advertiser 120. For example, a surf shop interested in selling surfboards specifies targeting criteria associated with a marketing campaign. The specified targeting criteria identify users associated with locations in California or Hawaii who the surfing shop would like to target with ads for a surfboard, as these users may be more likely to be interested their product than users associated with other locations. Targeting criteria are further described below in conjunction with FIG. 2.

An advertiser 120 may also wish to expand the audience beyond those customers identified in the provided customer list. In some embodiments, the online system 110 expands the audience by targeting one or more additional users of the online system 110 that are, in some way, associated with the one or more customers matching users meeting one or more targeting criteria. Targeting criteria specified by an advertiser 120 in the example above may include one or more of geographic locations, behaviors such as shopping habits, credit history, an interest, an age, or any combination thereof. For example, an advertiser 120 such as a karate dojo in the city of Mountain View, Calif., might be interested in targeting customers interested in physical fitness in the state of California. It should be noted that in various embodiments, interests may be comprise an association with one or more social networking objects stored on the online system 110. Social networking objects are further described below in conjunction with FIG. 2. Targeting criteria may also include behaviors such as shopping habits associated with a user or connections of the user.

Returning to the example above, the karate dojo might choose to target additional users of the online system 110 associated with their customers. For example, the karate dojo may choose to target users between the ages of 18 and 25 who are associated with behaviors associated with physical activities (e.g., going hiking or mountain climbing) and are connected to their current customers via the online system 110. Alternatively, an advertiser 120 may specify targeting criteria associated with any combination of behaviors and interests to expand its audience. In still other embodiments, targeting criteria may be personally identifiable information (PII) maintained by the advertiser 120 such as an email address, a phone number, a first name, a last name, a DOB, an email address, or any combination thereof. Additional methods of generating a custom audience are further described below in conjunction with FIG. 2.

FIG. 2 is a block diagram of one embodiment of the architecture of the online system 110. The online system 110 shown in FIG. 2 includes an interface 205, an advertiser profile store 210, a user profile store 215, a content store 220, a user identification module 225, a custom audience store 230, a web server 235, an edge store 240, and a geo match module 245. Additionally, one or more modules may communicate with the hashing module 217, hash store 218, and lookalike identification module 219 in order to perform one or more functionalities described herein. In other embodiments, the online system 110 may include additional, fewer, or different components for various applications. Conventional components such as network interfaces, security functions, load balancers, failover servers, management and network operations consoles, and the like are not shown so as to not obscure the details of the system architecture.

The interface 205 facilitates the various custom audience services. In some embodiments, an advertiser 120 creates an account with the online system 110 using the interface 205. In various embodiments, the advertiser 120 creates an account and provides information to the online system 110 via interface 205. The advertiser account may be stored in the advertiser profile store 210 including one or more targeting criteria (e.g., interests and behaviors). For example, the interface may communicate with the advertiser profile store 210 and store information provided by an advertiser 120. The interface 205 is one means for interfacing with an advertiser 120 and third-party database 130 via network 150. In an embodiment, the interface 205 may also enable communication between modules of the online system 110. For example, the interface 205 may receive a hashed customer list from an advertiser 120 and store the received hashed customer list in hash store 218. In another example, the interface 205 facilitates receiving and storing hashed customer lists, performing a user identity match, performing a geo-tile match, and generating and storing custom audiences via one or more modules comprising the online system 110. In still other embodiments, the interface 205 facilitates API access via web server 235. Modules of the online system 110 are further described below.

In one or more embodiments, the interface 205 generates and presents a GUI to an advertiser 120, through which an advertiser 120 may upload hashed customer lists for the generation of a customer database. In one embodiment, the interface 205 may allow the user to specify one or more targeting criteria to target additional users of the online system 110. The targeting criteria may include demographic information such as a gender, an age range, a geographic location, or an income level. In other embodiments, the targeting criteria may additionally include interests and behaviors that the advertiser may use to augment the number of users in the generated custom audience. For example, the interface 205 may enable an advertiser 120 that is a rock climbing gym to choose to target other lookalike users who are “males or females between the ages of 18 and 25 and are interested in rock climbing and go to a gym once a week.” Lookalike users are further described below in conjunction with FIG. 2.

Each advertiser 120 is associated with an advertiser profile stored in the advertiser profile store 210. Each advertiser 120 may be associated with an identifier such as an advertiser ID and a username associated with an advertiser profile stored in the advertiser store 210. For purposes of convenience, references herein to information such as a custom audience “associated” with an advertiser 120 are understood to mean an association in a database such as the custom audience store 230 and an advertiser store 210. An advertiser profile may include one or more targeting criteria (e.g., interests and behaviors). In other embodiments, the advertiser profile associated with an advertiser 120 may also include a received hashed customer list and a match priority selection to be used to identity one or more users of the online system 110 to customers associated with the advertiser 120. The process of performing the match is further described below.

### Matched Users

Similarly, each user of the online system 110 is associated with a user profile, which is stored in the user profile store 215. A user profile includes declarative information about the user that was explicitly shared by the user. In one or more embodiments, the user profile store 215 also includes profile information inferred by the online system 110. For example, if a user of the online system 110 posts a picture of that user eating a donut from a particular donut store the online system 110 may infer an interest in the particular donut store. Examples of information stored in a user profile include biographic, demographic, and other types of descriptive information, such as work experience, educational history, gender, hobbies or preferences, and the like. The user profile store 215 may also store a home location including a street address associated with the user where mail can be received. Similarly, a business address is a location including a street address associated with the business where mail can be received. In one or more embodiments, the user may manually declare a home or business address associated with a street address where mail can be received. In still other embodiments, the home location information is inferred based on a geographic location (e.g., GPS coordinate) associated with the user device 140, and includes a street address. For example, the user profile store 215 could store, as the home location, a location most often associated with the user device 140, the location indicating a street address associated with a residential location such as a home address, or a business address. For example, if a user device 140 associated with a user of the online system 110 is most often associated with a location corresponding to the address, “123 Main Street, Menlo Park, Calif.,” between the hours of 6 PM and 9 AM (e.g., based on mapping known GPS locations of the user device 140), the online system 110 may infer that the street address “123 Main Street, Menlo Park, Calif.” is the user's home address.

The declarative information stored in the user profile store 215 may include a hashed value resulting from a hash function applied to an existing PII attribute. That is, the hash value is the result of a hash function (e.g. MD5) to a PII attribute declared by the user. In one or more embodiments, the presence of a hash value for a particular PII attribute indicates that the user has previously provided that PII attribute to a user of the online system 110. For example, if a hash value associated with a particular PII attribute is not available in the user profile store 215, then the user did not declare the PII attribute to the online system 110.

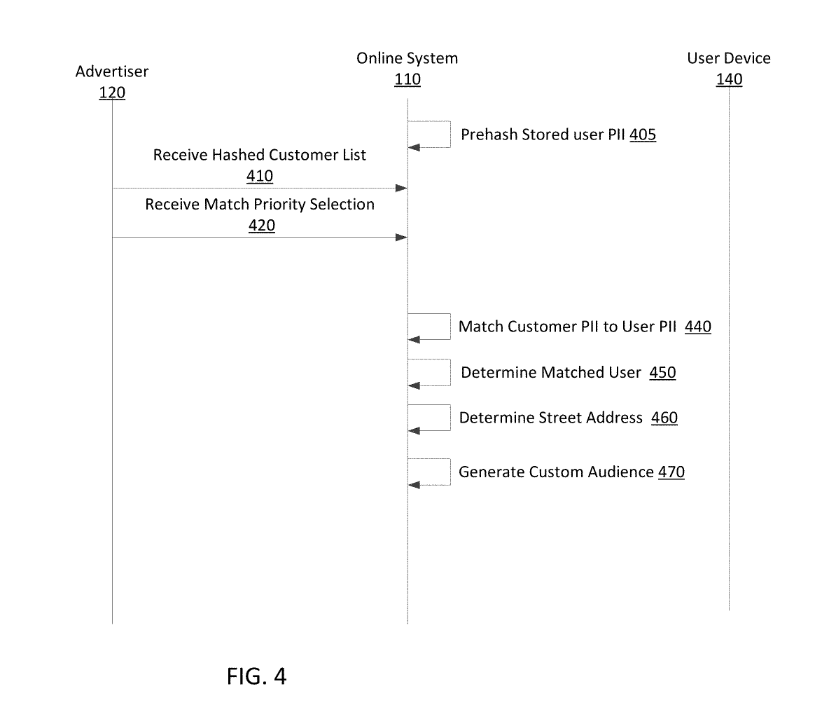

The online system 110 may include one or more social networking objects provided by or otherwise associated with the user, such as images or videos. It should be noted that in various embodiments the stored social networking objects are further associated with a location. A user profile in the user profile store 215 may also maintain references to actions performed by the user on content items in the content store 220. For example, an action performed by a user on a content item may be expressing interest, posting a comment, creating a post, sending a message. In various embodiments, actions performed on a social networking object are used to generate a custom audience as further described below in conjunction with FIG. 4.

A user profile may include information used by a user of the online system 110 to access the online system 110. For example, when a user logs into the online system 110, the online system 110 stores a device identifier of a user device 140 used to log into the online system 110 (e.g., an Internet Protocol (IP) address associated with the user device 140) in the user profile associated with the user. Login credentials associated with a user of the online system 110 (e.g., a username and a password) associated with the user profile associated with the user may be stored by the online system 110. In other embodiments, the online system 110 may also store information identifying login credentials the user used to log into the online system 110 including a time associated with each login to the online system 110 by the user. The online system 110 may also retrieve information identifying a user from a request by the user to login to the online system 110 (e.g., a user identifier from a network address). In other embodiments, the online system, alternatively, retrieves an identifier of an application from which the request was received (e.g., a browser identifier) from the received login request. Additionally, the online system retrieves a unique session identifier associated with the received login request and stores the retrieved information in the user profile associated with the user.

The online system 110 updates a user profile associated with a user based on information received from the user. For example, if a user updates login credentials used to access the online system 110, the online system 110 modifies the user profile associated with the user to include the updated login credentials. By way of example, as a user accesses the online system 110 from a different user device 140, the online system 110 modifies the user profile associated with the user to include device identifiers or other information identifying the different user device 140 (e.g., Internet Protocol addresses associated with the different user device 140).

While user profiles in the user profile store 215 are frequently associated with individuals, allowing individuals to interact with each other via the online system 110, user profiles may also be stored for entities such as businesses or organizations. The entity may post information about itself, about its products or provide other information to users of the online system 110 using a brand page associated with the entity's user profile. It should be noted that in one or more embodiments, the entity may be an advertiser 120. Users of the online system 110 may perform an action associated with the entity. For example, a user may express an interest in the entity or products and services associated with the entity. A user profile associated with the brand page may include information about the entity itself, providing users with background or informational data about the entity. In various embodiments, such an expression of interest in or association with an entity may be utilized to generate a custom audience and is further described below.

The content store 220 stores one or more social networking objects such that each stored object represents various types of social content. Examples of social content represented by a social networking object include a page post, a status update, a photograph, a video, a link, a shared content item, a gaming application achievement, and a check-in event at a local business. In various embodiments, the social networking objects may be associated with a location including a street address. For example, a status update made by a user of the online system 110, “Natalie is excited”, is also associated with a street address location such as “123 Main St., Menlo Park, Calif.” In one or more embodiments, social networking objects are generated by users of the online system 110 and stored by the content store 220. Note that social networking objects may be received from third-party applications (e.g., gaming applications) or third-party websites separate from the online system 110 (e.g., news webpages). In fact, online system users are encouraged to communicate with each other by posting text and content items of various types of media to the online system 110 through various communication channels. This increases the amount of interaction of users with each other and increases the frequency with which users interact within the online system 110. User profiles stored in user profile store 215 and social networking objects stored in content store 220 may be used to perform a user identity match and are further described below.

### User Identity Match

The user identification module 225 matches customers in the customer list received from an advertiser 120 with users already known to the online system 110. As described above, information about online system users matching customers in a customer list is stored in the user profile store 215. Data expressed about a customer in a customer list may differ from the data about the corresponding user in the online system 110. In one embodiment in which the customer list contains hashes of customer PII data, the hashed PII is compared to the hashed PII of users associated with the online system 110. The process of matching hashed values is further described below.

In various embodiments in which customer lists from the advertisers 120 are hashed, the PII associated with users of the online system 110 are pre-hashed by a hashing module 217. It should be noted that by pre-hashing user PII, the latency associated with matching user data with the hashed customer data associated with the received customer list, may be reduced. In some embodiments, in order to provide a greater reduction in match latency, for each user in the user profile store 215, the values of the attribute sets for each possible level of quality are pre-hashed, and the hashes stored in a hash store 218. In one embodiment, a single type of hash function (e.g., MD5) is used in all cases. In other embodiments, different hash functions may be used, in which case an identifier of the hash function used is stored along with the hashed data. This hashed PII stored in the hash store 218 is matched to the hashed PII received from an advertiser 120 to identify one or more users of the online system 110 that the advertiser would like to target with a marketing campaign.

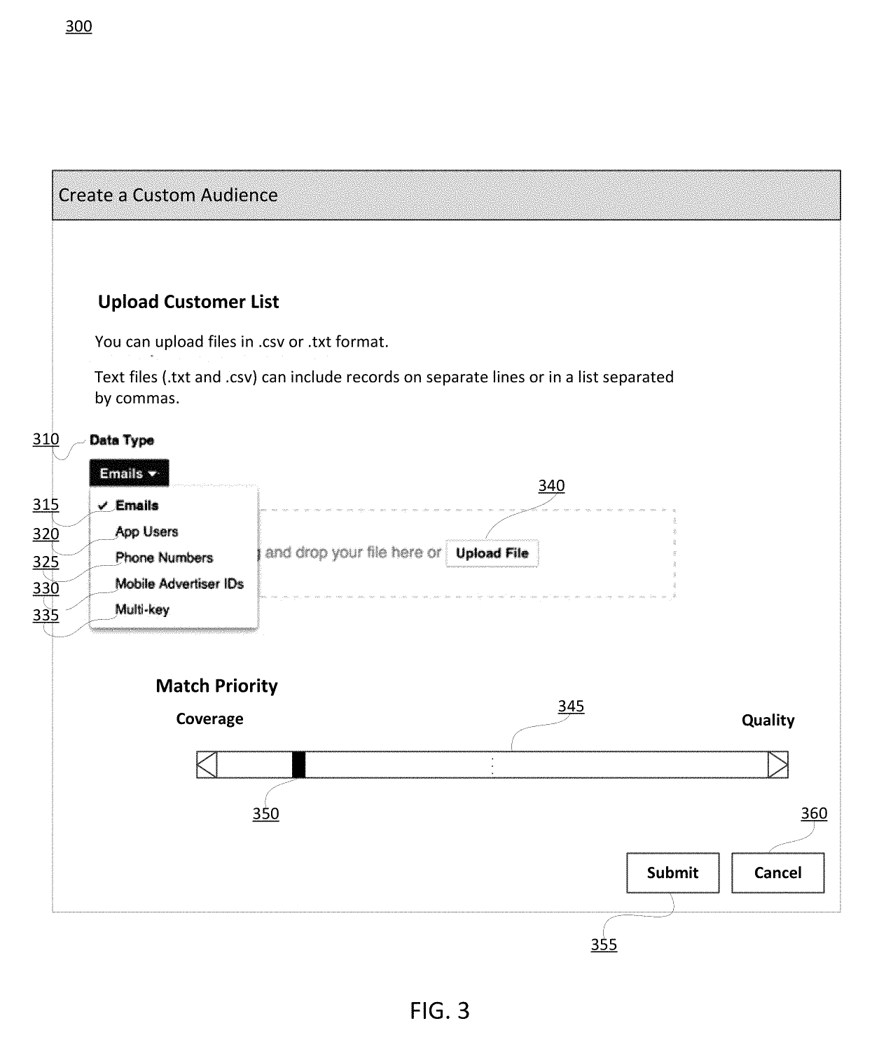

The match priority allows an advertiser 120 to prioritize one of: a match coverage or a match accuracy. Said another way, the match priority allows an advertiser 120 to indicate a minimum level of match quality for the match. The advertiser 120 may select a match priority indicating that the match be performed prioritizing match coverage over match accuracy (a match quality level of low) or prioritizing match accuracy over match coverage (a match quality level of high). For example, if a particular credit card company were interested in targeting the actor Tom Cruise in Los Angeles, Calif. with a direct mail campaign for a credit card (but not additionally targeting others with similar data, such the same name or the same city), it would select to prioritize the match for match accuracy rather than match coverage. Alternatively, if the same credit card company were willing to also to target other related people so that the actor Tom Cruise ends up being included in the target group, even if a precise match with his data cannot be found, it would select to prioritize the match for match coverage rather than match accuracy. In one or more embodiments, the match is performed based on multiple categories of PII wherein each category is of increasing specificity, starting with the most restrictive categories and proceeding to less restrictive categories if matches are not found, until a specified minimum quality level is reached. Match prioritization is further described below and in conjunction with FIG. 3.

In one or more embodiments, the user identification module 225 performs a street address match based on the advertiser's match priority selection. In some embodiments, the online system 110 performs a match by sequentially attempting matches based on PII attributes with decreasing levels of specificity. In one embodiment, if the requisite PII attribute is not available for a given user at a given specificity level, a hash for the <user, specificity level> is not computed. As an example, a first match is attempted using the PII attribute “email address” (if a hash value exists for it), email address being in this example the most precise, restrictive set of PII. If the attribute set (namely, email address) in the previous example fails to return a match (e.g., because the data for the customer in question does not include an email address, or the email address is not found in the list of users of the user profile store 215), a match is attempted with a set of PII attributes with a lower level of specificity such as, “last name, first name, DOB” (if a hash value exists for it). If the combination of PII attributes above also fails to return a match, another combination of PII attributes with a still-lower-level of specificity such as, “first name, last name, zip code” or “first name, last name, state” is attempted (if a hash value exists for it).

Returning to the above example regarding a match for the actor Tom Cruise (as specified in the customer list provided by an advertiser 120), the user identification module 225 attempts to perform a match based on a hash of Tom Cruise's email address, if it is known; if that fails to have a match in the hash store 218, a hash of the combination of first name, last name, and DOB is attempted; if that fails to have a match in the hash store 218, the user identification module 225 proceeds to a still lower level of specificity, such as a hash of a combination of first name, last name, and zip code. In one embodiment, this process continues until a given number of matches (e.g., 1) is generated. It should be noted that the match process described above, via example, is described for an example customer list comprising just one customer, ‘Tom Cruise’. In other embodiments, the customer list comprises a plurality of customers and the match process described above is repeated for each user in the customer list. In various embodiments, if no match is found for the PII provided by the advertiser 120, or if the number of matches is too large, the online system 110 presents the advertiser 120 with a flag (e.g., a warning message within a user interface).

In the interest of convenience a user of the online system 110 matched via any one or more PII attributes to a customer associated with the advertiser 120 is referred to herein as a “matched user.”

In various embodiments, based on the degree of match quality specified by the advertiser, the user identification module 225 communicates with the lookalike identification module 219 to identify users that are similar to one or more matched users. Lookalike users are users of the online system 110 who may share one or more edges with a matched user, representing some form of relationship with the matched user. (Edges are described below with respect to the edge store 240.) For example, lookalike users identified by the lookalike identification module 219 include users who performed an action such as expressing an interest in a third-party webpage associated with the advertiser 120, becoming associated with a particular behavior, or visiting a webpage. In other embodiments, a lookalike user is a user who is connected, in some way, to a matched user (e.g., a friend, a shared interest or behavior). The lookalike identification module 219 enables an advertiser 120 to increase the coverage of a generated custom audience. In one or more embodiments, an advertiser 120 implicitly specifies whether, or to what extent, to include lookalike users by selecting a particular match priority level; in other embodiments, the advertiser 120 explicitly specifies this, e.g., through a checkbox indicating whether to include lookalike users. In one embodiment, the match priority level is graphically specified through the use of a slider, as described below. The generation of lookalike users is further described below and in conjunction with FIG. 3.

In some embodiments, the lookalike identification module 219 limits the lookalike users to those with similar street addresses to those in the customer list. This is particularly suitable for purposes of providing advertisements or other promotions that are location-specific (e.g., a karate dojo in Mountain View).

### Street Address Match

The geo match module 245 determines a street address of a customer by matching the customer with users of the online system 110 based on one or more PII associated with a matched user. In an embodiment, the online system 110 maintains exact street address information associated with a user. For example, the online system 110 uses information from multiple sources such as a current city associated with a user profile stored in the user profile store 215, an IP address, and data from mobile devices to gather exact street address information about a user if location services are enabled. In other embodiments, location information may be determined based on aggregated information about one or more edges associated with the user (e.g., the location information of a user's friends).

In one embodiment, if the online system 110 lacks a street address for a given user, the street address for the user may be determined based on information received from a third-party database 130 (e.g., a tile service). It should be noted that the online system 110 may determine a street address information in preprocessing and store the determined street address in the user profile 215. In one or more embodiments, the online system generates a geo-tile and transmits the generated geo-tile to a third-party database 130 including one or more PII (e.g., first name, last name, phone number). The dimensions of the generated geo-tile may be determined by a match priority selected by an advertiser 120. Typically, the lower the match priority setting the larger the generated geo-tile.

In order to accurately determine a street address for one or more matched users, the online system 110 may receive a populated geo-tile from a third-party database associated a set of matched users. The populated geo-tile is used to determine a street address associated with the matched user by matching PII associated with residents of the geo-tile with that of one or more matched users. For example, the populated geo-tile contains one or more <key, value> pairs associated with residents in a particular populated geo-tile, such as the keys <First name, Last Name, phone number, street address> and their corresponding values. The online system 110 may then match the user's known information against the keys and values in the populated geo-tile to identify a matching user, and then associate the user with the value of the “street address” key for the matching user in the geo-tile.

The geo match module 245 may also be configured to normalize values of the attribute sets before they are hashed in order to normalize the data so that equivalent data will generate an identical hash value. For example, if a street address associated with the generated geo-tile received from a third-party database 130 were “Apt. 4, 123 Main St., Menlo Park, Calif., 94025,” it might be normalized to “123 Main St., Apt. 4, Menlo Park, Calif., 94025” before hashing. In an embodiment, the geo match module 245 may be configured to normalize the received street address by removing special characters such as spaces, thereby conforming the addresses to correspond to established standards. Returning to the example above, the received address may be normalized to “123 Main St., Apt. 4, Menlo Park, Calif. 94025” by the removal of spaces. In various embodiments, the online system 110 normalizes addresses to a standard such as ISO 3166 before performing a hashed match.

In one or more embodiments, the custom audience store 230 stores one or more generated custom audiences associated with an advertiser 120. For example, the custom audience store 230 may be configured to store one or more matched users of the online system 110 as a <key, value> pair associated with an advertiser 120. For example, the <key, value> pair is <advertiserID, userID, street address>. The custom audience store 230 also stores names including the first name and last names of one or more matched users.

Keys used to index one or more values associated with an advertiser 120 may identify the data stored in the custom audience store 230. In various embodiments, keys are a userID, advertiserID, or audienceID as described above in conjunction with the interface 205. The data or values stored by the custom audience store 230 are hashed by the online system 110 and the data contained in the custom audience store 230 are hashed representations of values associated with a given key. For example, a value may be a street address associated with one or more keys such as a userID, an advertiserID, and an audienceID.

As described above in conjunction with interface 205, the custom audience store 230 may store a single file associated with key value (e.g., audienceID, userID, or advertiserID) listing contents of the generated custom audience. For example, the audience store 220 may store one or more files listing one or more users of the online system 110 matched to a customer of the advertiser 120 and including a determined mailing address. The custom audience may be represented in the file in different ways in different embodiments, such as a comma-separated text file, or a database such as a relational database management system table.

Returning briefly to interface 205, in some embodiments the interface 205 also generates a graphical user interface (GUI) to enable an advertiser 120 to upload a customer list that the advertiser would like to target with a direct mail marketing campaign. The GUI may additionally include a slider to enable match priority selection. The match priority selection is further described above in conjunction with the user identification module 225.

The GUI generated by the interface 205 may include one or more options for managing the generated custom audience list. Options for managing the generated custom audience include “new”, “open”, “save”, “delete”, “view”, and “reset”. In some embodiments, the generated GUI may include additional options such as flagging a generated custom audience with an error or indicating that the generated custom audience was ready to be utilized in a mail marketing campaign by the advertiser. For example, the online system 110 may flag a generated custom audience with the color red to indicate an error. For instance, some possible errors may be, “audience too small”, “high data invalidation rate” or “audience too large”. If, on the other hand, a custom audience was generated successfully the generated custom audience may be flagged with the color green indicating a status that indicates if a custom audience is ready to be used in a direct mail campaign. In various embodiments, the status may be “installed,” indicating that the custom audience is available to the advertiser 120. As can be readily appreciated by one skilled in the art, in other embodiments, other or additional colors may be used flag an error or a successfully generated custom audience. GUIs are further described below in conjunction with FIG. 3.

The interface 205 may also enable access to the online system 110 via an API as described above. Through the API, advertisers 120 may upload a hashed list of customers including one or more PIIs associated with customers of the advertiser 120. In other embodiments, the API may be configured to receive commands including authorization credentials such as a user name and a password associated with the advertiser 120. Commands received via the API may include one or more commands designed to enable the advertiser 120 to upload hashed customer lists including a match priority selection. In various other embodiments, the interface 205 may also be configured to receive one or more targeting criteria as well as commands to enable the advertiser 120 to manage the generated custom audience. Responses sent from the online system 110 may include a status response or other error message associated with a generated custom audience. The interface 205 may also be configured to transmit a generated custom audience in response to a received HTTP request to webserver 235. In various embodiments, the generated custom audience is transmitted as a file or other storage format comprising one or more <key, value> pairs such as <userID, Street Address>. In still other embodiments, values associated with a key are (e.g., street addresses) are hashed values of the PII associated with a user of the online system 110 matched to a customer associated with the advertiser 120. In one or more embodiments, API access to the online system 110 is enabled by the webserver 235, further described below.

The online system 110 may also provide a received advertisement to one or more users of the online system 110 associated with a generated custom audience. In one or more embodiment, the provided advertisement is provided to users associated with a generated custom audience based on a determined street address. For example, an advertiser (e.g., ecommerce website) may upload a list of email addresses associated with their customers to the online system 110 and selects to target only those customers located in Mountain View, Calif. with an advertisement via the interface 205. In an embodiment, an advertisement provided for display may be displayed in a user interface associated with the user device 140.

In other embodiments, the interface 205 is configured to communicate with a third-party mailing service and the online system 110 may generate the direct mail campaign. For example, the online system 110 can transmit the generated custom audience to one or more third-party mailing services such as the USPS, FEDEX, or UPS.

The web server 235 links the online system 110 via the network 150 to the one or more user devices 140, one or more advertisers 120, and one or more third party databases 130. The web server 235 serves web pages, as well as other content, such as JAVA®, FLASH®, XML and so forth. The web server 235 may receive and route messages between the online system 110 and the user device 140, for example, instant messages, queued messages (e.g., email), and text messages, short message service (SMS) messages, or messages sent using any other suitable messaging technique. In various embodiments, a user may send a request to the web server 235 to upload information (e.g., images or videos) that is stored in the content store 220. It should also be noted that in other embodiments, the web server 235 facilitates the presentation of a GUI and receiving a customer list via the GUI generated by the interface 205. Additionally, the web server 235 may provide API functionality to send data directly to native user device operating systems, such as IOS®, ANDROID™, WEBOS®, or BlackberryOS.

The webserver 235 may be configured to accept and respond to one or more HTTP POSTS, HTTP GETS, etc. As described above in conjunction with the interface 205, the webserver 235 may enable advertiser 120 to interact with the online system 110 through interface 205 via an API. The received responses may comprise a request including commands for managing generating custom audience.

The edge store 240 stores information describing connections between users and other objects on the online system 110 as edges. Some edges may be explicitly defined by users, allowing users to specify their relationships with other users. For example, users may generate edges with other users that parallel the users' real-life relationships, such as friends, co-workers, partners, and so forth. Other edges are implicitly generated when users interact with objects in the online system 110, such as expressing interest in a page on the online system 110, sharing a link with other users of the online system 110, and commenting on posts made by other users of the online system 110.

The edge store 240 also stores information about edges, such as affinity scores for objects, interests, and other users. Affinity scores, or “affinities,” may be computed by the online system 110 over time to approximate a user's interest in an object or in another user in the online system 110 based on the actions performed by the user. A user's affinity may be computed by the online system 110 over time to approximate a user's interest in an object, in a topic, or in another user in the online system 110 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 240, in one embodiment. Alternatively, each interaction between a user and a specific object is stored as a separate edge. In some embodiments, connections between users may be stored in the user profile store 215, or the user profile store 215 may access the edge store 240 to determine connections between users.

### User Interface

FIG. 3 illustrates a graphical user interface (GUI) 300 provided by the online system to an advertiser, using which the advertiser can create a custom audience in accordance with one embodiment. The GUI 300 shown by FIG. 3 includes a data type selector 310, an upload button 340, and a match priority slider 345 including an indicator 350. The hashed customer list may be uploaded to the online system 110 via the upload button 340 associated with a data type using the data type selector 310. In various embodiments, the uploaded customer list may also include a match quality selection using the match priority slider 345. The GUI 300 may further include a submit button 355. The submit button 355 may be configured such that if it receives a “click” or is otherwise interacted with, the submit button 355 causes the online system 110 to generate a custom audience based on the received customer list. Similarly, an interaction with the cancel button 360 cancels all the selections made using the interface 300 and may delete the uploaded hashed customer list.

It should be noted that an advertiser 120 may make a selection on interface 300 by performing a “click”, “tap”, or other form of interaction between an advertiser 120 and the interface 300.

Upon a received interaction with the upload button 340, the interface 300 provides instructions to the browser to generate a dialog box on the advertiser's computer. In one or more embodiments, the generated dialog box is a prompt designed to enable the advertiser to select one or more locally stored customer lists. For example, when the advertiser 120 “clicks” on the upload button, the computer associated with the advertiser 120 generates a file-explorer interface and the user may select one or more customer lists. In various embodiments, the customer list may be a text file containing comma-separated values (CSV) file format or other table or database file. The customer list contains a customer name and one or more associated hashed PII, e.g., arranged as a <key, value> pair. In one or more embodiments, the <key, value> pair associated with a customer list is <name, selected data type>. In other embodiments, the <key, value> pair comprises a customer name and multiple data types such as an email address and a phone number associated with a given customer.

In still other embodiments, the advertiser 120 may select a data type associated with the uploaded customer list using the data type selector 310. Selectable data types include emails 315, App Users 320, Phone Numbers 325, Mobile Advertiser IDs 330 and multi-key 335. The selection of a data type associates the selected data type with the hashed PII in the uploaded customer list. For example, the selection of the data type “email” 315 indicates that the hashed PII associated with the one or more customers in the uploaded customer list are email addresses. In other embodiments, the advertiser 120 may associate the identified customers in the uploaded customer list with a email address, phone number, custom ID associated with an advertiser 120 or any combination thereof, by selecting the Email data type 315, Phone Number data type 325, Mobile Advertiser IDs 330 data type, or multi-key 335 data type respectively.

The match priority slider 345 allows—e.g., via the use of an indicator 350—the user to indicate a degree to which to emphasize match coverage vs. match quality. That is, the indicator 350 specifies a minimum level of match quality associated with the selected match priority. For example, in the user interface of FIG. 3, an indicator 350 situated to the extreme left of the match priority slider 345 indicates a selection of match coverage over match quality (the greatest emphasis on coverage), while an indicator 350 to the extreme right indicates a selection of match quality over match coverage (the greatest emphasis on quality). In other embodiments, the advertiser 120 may utilize the left and right arrows associated with the match priority slider 345 to move the indicator 350 to a location in between the left and right extremes of the match priority slider 345. Thus, the advertiser 120 selects a match priority that is combination of match coverage and match quality. A selected match priority level corresponds to a set of PII fields to use when performing a match between a customer and user. For example, in one embodiment a match priority of match quality uses highly specific PII such as an email address for user matching, while a match priority of match coverage uses less specific PII, such as a first name, DOB, city, or zip code. It should be noted that, in an embodiment, a match priority of match coverage also leads to the inclusion of one or more lookalike users in the generated custom audience; as the indicator 350 moves toward coverage and away from quality, the number of lookalikes to include in the generated custom audience increases.

FIG. 4 is an interaction diagram illustrating operations involved in generating a custom audience associated with one or more customer lists received from an advertiser 120, according to one embodiment. Initially, the online system 110 pre-hashes 405 stored user PII. Next, the online system 110 receives 410 a (e.g., hashed) customer list from an advertiser 120. As described above in conjunction with FIG. 2, advertiser 120 may upload a customer list, including one or more PII values associated with customers, to the online system 110 via a GUI or API. In various embodiments, the online system 110 provides instructions (e.g., as scripting code in a web page) to a device associated with the advertiser 120 to locally hash the customer list such that only a hashed customer list is received 410 by the online system 110, thereby preventing leakage of customer data. Hashed customer PII is matched 450 to the pre-hashed user PII based on the received 420 match priority selection.

The online system 110 determines 460 a street address associated with the determined 450 matched user. A street address associated with a user may be determined 460 based on PII declared by the user and stored by the online system 110. In other embodiments, a street address associated with the user is inferred by the online system 110 based on one or more social media objects such as interests, behaviors, connections, and other edges associated with the user. In still other embodiments, street addresses associated with a user may be inferred from a GPS location associated with a user device 140. In various embodiments, the online system 110 extracts a geo-tile associated with the user (e.g., a geo-tile in which the user has been observed to spend most of his or her time, presumably his or her home). The extracted geo-tile may be provided to a third-party database in order to receive street address information.

Based on the match of step 440, the online system 110 generates 470 a custom audience, where the data of the users of the audience include a street address, so as to enable provision of content (such as advertisements) to those users. In various embodiments, the generated 470 custom audience also includes one or more lookalike users of the online system 110. The number of lookalike users of the online system 110 may be based on the match priority selection received 420 from the advertiser 120. Lookalike users are further described above in conjunction with FIGS. 2 and 3.

The online system 110 may also provide for display an advertisement to one or more users in a generated 470 custom audience via an interface. For example, the online system 140 may provide an advertisement on a website associated with the online system 110 (e.g., newsfeed, activity feed). The online system 110 may additionally only provide advertisements to users in a generated custom audience that are associated with a geographic location based on a determined street address. For example, the online system 110 may target users in a Custom Audience in San Francisco, Calif. with cheap flights from San Francisco to New York City on behalf of an Airline.

In some embodiments, the online system 110 (either directly, or through a third party printing and mailing service) generates printed advertisements or other promotions. In still other embodiments, the online system 110 mails the generated advertisements to one or more users identified in the custom audience, using the mailing addresses determined for those users.

### Other Considerations

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving, by an online system, from a third party a customer list, the customer list comprising a plurality of customers, the customer list including hashes of personally identifying information (PII) of each of the plurality of customers, the PII comprising one or more categories including at least one of an email address, a gender, and a date of birth;
receiving, by the online system, from a third party, a match priority selection indicating a minimum level of match quality;
determining a set of PII attributes to match based on the received match priority; and
generating a custom audience by:
matching the hashes of PII of customers of the plurality of customers with hashes of users of an online system based, in part, on the determined set of PII attributes associated with the received customer list, and
determining street addresses associated with matched users of the online system.

2. The method of claim 1, wherein receiving the customer list further comprises:
providing a web page with scripting code to generate the hashes of PII of the received plurality of customers.

3. The method of claim 1, further comprising:
providing a graphical user interface;
receiving a selection of a data type via the graphical user interface; and
receiving one or more targeting criteria via the graphical user interface.

4. The method of claim 1, wherein matching a user further comprises determining one or more lookalike users associated with a matched user.

5. The method of claim 1, wherein determining a street address associated with a matched user comprises:
generating a geo-tile associated with the matched user;
transmitting the generated geo-tile to a tile service;
receiving a populated geo-tile from a tile-service, the populated geo-tile including a plurality of users having one or more PII values and including street addresses;
normalizing the street addresses of the populated geo-tile; and
matching one of the normalized street addresses to a matched user of the custom audience.

6. The method of claim 1, further comprising providing, to a user of the custom audience when the user is logged onto the online system, an advertisement of the third party.

7. A method for generating a custom audience comprising:
receiving from an advertiser a customer list and a match priority selection indicating a minimum level of match quality, the customer list comprising a plurality of customers associated with the advertiser;
determining a set of PII attributes to match corresponding to the received match priority selection; and
generating a custom audience by:
matching customers of the plurality of customers with users of an online system based on the determined set of PII attributes associated with the customers; and
determining street addresses associated with the matched users of the online system.

8. The method of claim 7, wherein receiving the customer list further comprises:
providing a web page with scripting code to generate the hashes of PII of the received plurality of customers.

9. The method of claim 7, further comprising:
providing a graphical user interface;
receiving a selection of a data type via the graphical user interface; and
receiving one or more targeting criteria via the graphical user interface.

10. The method of claim 7, wherein generating a custom audience further comprises determining one or more lookalike users associated with a matched user.

11. The method of claim 7, wherein determining a street address associated with a matched user comprises:
generating a geo-tile associated with the matched user;
transmitting the generated geo-tile to a tile service;
receiving a populated geo-tile from a tile-service, the populated geo-tile including a plurality of users having one or more PII values and including street addresses;
normalizing the street addresses; and
matching the normalized street addresses to a matched user.

12. The method of claim 7, further comprising providing, to a user of the custom audience when the user is logged onto the online system, an advertisement of the third party.

13. A non-transitory computer-readable storage medium comprising instructions executable by a processor, the instructions comprising:
instructions for receiving a customer list including a match priority selection indicating a minimum level of match quality, the customer list comprising a plurality of customers associated with the advertiser;
instructions for determining a set of users wherein each of the users comprising users matching a customer associated with the an advertiser based on one or more determined PII attributes associated with the customers;
instructions for determining a street address associated with each of the one or more matched users;
instructions for generating a custom audience comprising at least: the matched user and the determined street address associated with the match user; and
instructions for storing the generated custom audience.

14. The non-transitory computer-readable medium of claim 13, wherein receiving a customer list further comprises:
providing instructions to generate a local hash of the customer list; and
uploading the hashed customer list to the online system.

15. The system of claim 14, wherein uploading the hashed customer comprises:
generating a graphical user interface;
selecting a data type; and
receiving one or more targeting criteria.

16. The system of claim 13, further comprising:
calculating a hashed list user PII;
storing the hast list of user PII.

17. The system of claim 13, wherein matching a user further comprises determining one or more lookalike users associated with a matched user.

18. The system of claim 13, wherein determining a street associated with a matched user further comprises:
generating a geo-tile associated with one or more matched use;
transmitting the generated geo-tile to a tile-service;
receiving a populated geo-tile from a tile-service including one or PII; and
normalizing the received street addresses;
matching the normalized street address to a matched user;

19. The system of claim 13, further comprising transmitting the stored custom audience to a customer.
